(19) United States
(12) Patent Application Publication
(10) Pub. No.: US 2019/0207853 A1
(43) Pub. Date: Jul. 4, 2019

(54) SELECTION OF INPUTS FOR LOOKUP OPERATIONS

(71) Applicant: Intel Corporation, Santa Clara, CA (US)

(72) Inventors: Cian FERRITER, Limerick (IE); Fei Z. WANG, Clare (IE); Richard WALSH, Garryspilllane (IE); John J. BROWNE, Limerick (IE)

(21) Appl. No.: 16/296,162

(22) Filed: Mar. 7, 2019

(51) Int. Cl. H04L 12/743; G06F 16/13; G06F 16/14; G06F 16/2453; H04L 29/06; G06F 16/901

(52) U.S. Cl. CPC H04L 45/7453; G06F 16/137; G06F 16/9014; G06F 16/24549; H04L 69/22; G06F 16/152

(57) ABSTRACT

A hash calculation is performed using a portion or portions of a packet that is to be transmitted or is received. The calculated hash value can be used to select an entry that defines how the packet is to be handled. The performance of the lookup operation can be monitored and if the hash calculation is resulting in excessive collisions or extra processing steps are needed in connection with the lookup operation, then the inputs to the hash calculation can be modified to attempt to improve the performance of the lookup operation. For example, if performance of the lookup operation meets a threshold level to trigger a change in inputs, then different inputs can be selected and specified for use.

### TECHNICAL FIELD

Various examples described herein relate to techniques for packet processing and more specifically to selecting inputs for a lookup operation used to determine a next action for processing a packet.

### BACKGROUND

Hash calculations are used to transform a bit stream or symbol into a shorter bit pattern that can be used as compact representations of the input bit stream or symbol. Hash calculations can be used in connection with searching lookup tables for relevant information. Using shorter bit patterns can increase a speed of searching or lookups, especially when the number of searchable entries is very large. Searching time can be reduced by selection of a hash function and internal data structures. However, if hashing multiple different input bit streams or symbols results in the same shorter bit pattern, a collision occurs and additional lookup operations are needed to find a proper match for the input bit stream or symbol.

Some approaches to reducing hash collisions, such as MurmerHash or Jenkins, have strived to avoid hash collisions by improving the speed or uniqueness of hash operations. Some approaches manually select hash input portions of a bit stream based on trial and error or a heuristic approach set at compile time.

### BRIEF DESCRIPTION OF THE DRAWINGS

FIG. 1 depicts an example scenario in which a traffic source originates traffic of packets or frames in accordance with some embodiments.

FIG. 2 depicts a flow chart of a known manner of processing packets using a virtual switch in accordance with some embodiments.

FIG. 3A depicts an example system that can be used in accordance with some embodiments.

FIG. 3B depicts an example operating environment in accordance with some embodiments.

FIG. 4 depicts an example of a system where a receiver can send performance information related to lookups based on input fields in accordance with some embodiments.

FIG. 5 depicts an examples of fields used to perform a lookup and fields suggested for use in accordance with some embodiments.

FIG. 6A depicts a process used to manage portions of packets used to lookup packet processing actions in accordance with some embodiments.

FIG. 6B depicts a process to selectively adjust a hashing calculation in accordance with some embodiments.

FIG. 7 depicts an example system in accordance with some embodiments.

FIG. 8 depicts an example network interface in accordance with some embodiments.

FIG. 9 depicts an example switch in accordance with some embodiments.

FIG. 10 depicts an example of a data center in accordance with some embodiments.

### DETAILED DESCRIPTION

In the networking context, hashing of received packets is commonly used in virtual switches to determine relevant information for received packets to decide how to process received packets. In current virtual switching setups, performance degradation (e.g., reduced speed of packet throughput) can occur due to hashing schemes that cause hash collisions. Colliding hashes can be detrimental to the performance of network nodes as it can lead to high central processing unit (CPU) utilization during lookup operations.

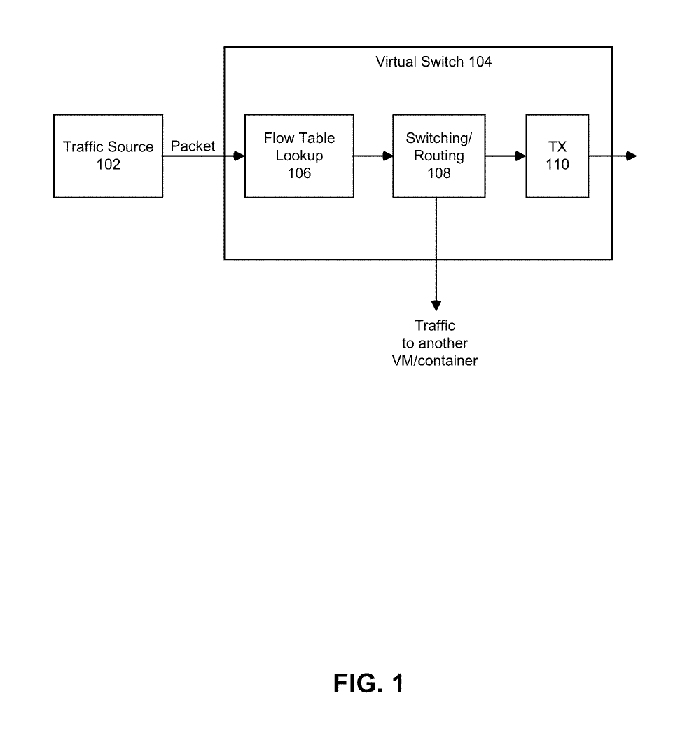

FIG. 1 depicts an example scenario in which a traffic source originates packets or frames for transmission or provides a packet for processing. Traffic source 102 can request transmission of a packet or provide a packet for processing. For example, traffic source 102 can be a virtual machine (VM), container, application, operating system, a packet transmitter, or other entity. Virtual switch 104 determines actions for processing packets using a flow table lookup 106. At compile time of virtual switch 104, fields of a packet can be specified to be used as an input of a hash calculation. For example, one or more portions of header fields can be selected as inputs to a hash calculation. However, if packets exhibit the same inputs to the hash calculation, then hash collisions can occur and packet processing speeds can diminish in order to perform additional lookup operations to find and update flow information associated with the packet. For example, a hash table can be queried to determine an egress port for a packet, packet classification, per-flow state maintenance, and network monitoring. Based on flow lookup for the packet, switching/routing element 108 provides the packet to another VM or container or for transmission to a wired or wireless network using transmit (TX) element 110.

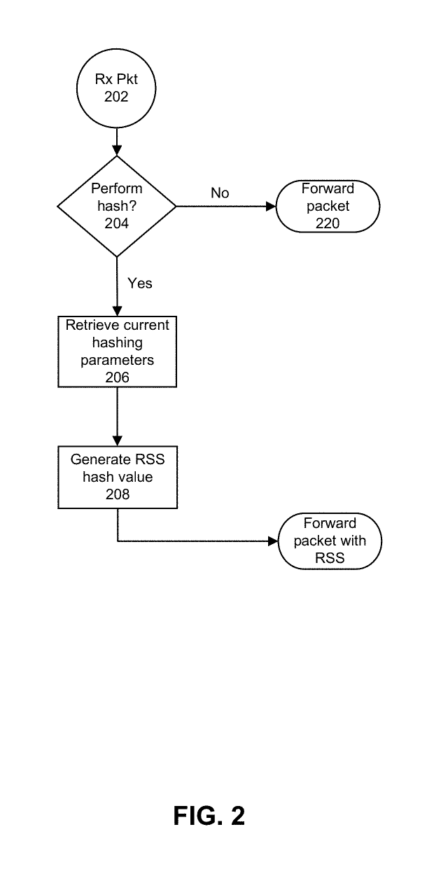

FIG. 2 depicts a flow chart of a known manner of processing packets using a virtual switch. At 202, a packet is received. The packet can be received from a network medium or made available for transmission (or both). At 204, a determination is made as to whether a hash is to be calculated on the packet. In some cases, packets available for transmission from a virtual machine (VM) or container at the vSwitch or its classifying application are not hashed whereas packets received from a network medium are to be hashed. If a hash is not to be performed, at 220, the packet can be forwarded to the networking destination application (e.g., vSwitch). If a hash is to be performed, then at 206, current hashing parameters are retrieved from the packet. The hash parameters are chosen up-front when the virtual switch is compiled based on what type of traffic is anticipated. For example, hashing parameters can include one or more of a packet's 5tuple (e.g., source IP address, source port number, destination IP address, destination port number, and protocol in use or a media access control (MAC) source or destination address). At 208, a receive side scaling (RSS) hash value can be generated using the hashing parameters. A hash calculation is performed in the vSwitch on the fields of the headers of the packet specified in the hashing parameters. The RSS hash value can be used to select a core to process the received packet and its associated queue. The received packet can be forwarded to the appropriate queue for processing based on the RSS hash value. For example, examples of RSS can include Microsoft® receive side scaling, Linux® receive side scaling, and so forth.

The hash calculation on the packet is used to lookup which action to perform on the packet. If an entry is found for the calculated hash and the packet is verified as associated with the entry (e.g., using a lookup involving additional portions of the packet beyond or including the hashing parameters), the action contained in this entry is performed and the packet is forwarded based on the action specified in the entry. If an entry is found, but the packet is not verified to use the entry, the lookup misses and a hash collision has occurred. If no entry is found in the lookup table, an up-call must be performed in order to determine the correct action to be carried out on the packet.

If the amount of lookup misses increase because the nature of traffic being sent through the virtual switch changes but the fields being used in the hash calculation do not vary, then performance of the lookup may be unacceptable. For example, if a Layer 4 source or destination port information was used in the hash calculation, but traffic changes so that the destination IP address changes but the Layer 4 source or destination ports stay the same, more collisions can occur and lookup performance can become unacceptable.

Various embodiments provide for changing fields used in a hash calculation in connection with packet classification and next action for processing a packet. In some embodiments, a system detects a packet is available for transmission or is received from a wired or wireless medium. A field selector determines which fields (or portions) of the packet to use in a hash calculation. The hash calculation can be used in connection with a flow table lookup whereby the hashed value is used to index a table to retrieve flow information for a packet. For example, if a collision rate of hash calculations is too high, then a lookup performance packet can be formed to inform a separate transmitter. The lookup performance packet can provide information to indicate a quality of a hash using one or more of: collision rate over a period of time, a percentage or number of table lookup misses over time, flow rule evictions from flow lookup tables over a period of time, installation rates of rules into flow lookup tables over a period of time. The transmitter, a separate device, or a local entity can receive the lookup performance packet or its information, determine which input(s) to use in a hash calculation, and transmit a feedback packet or feedback to the system to select the input(s) to use in a hash calculation. In some embodiments, the feedback packet or feedback can indicate to change a hashing calculation that is used.

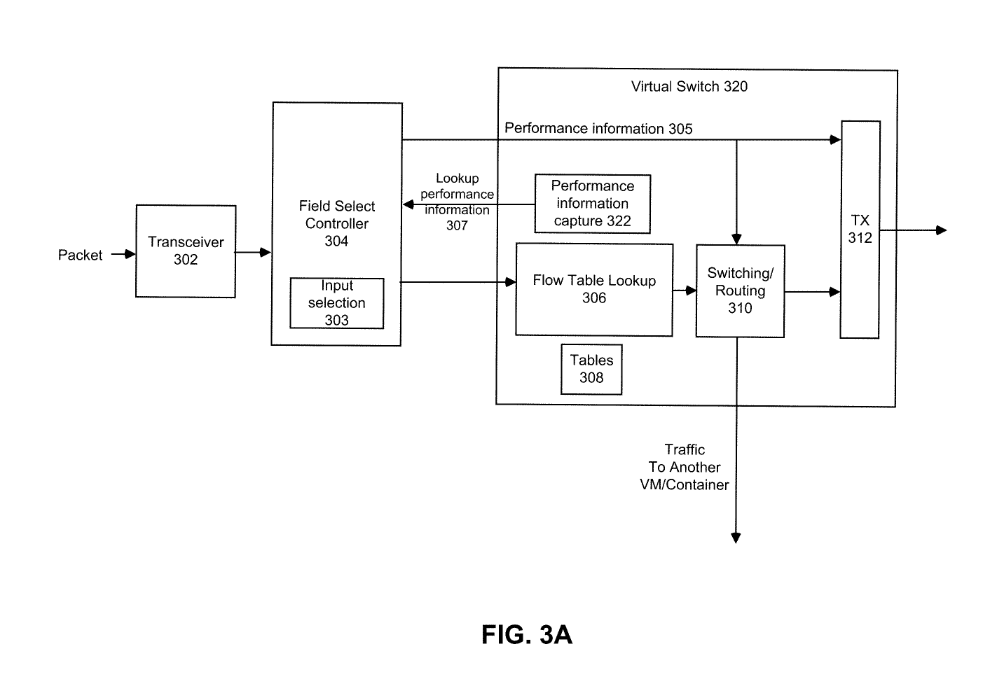

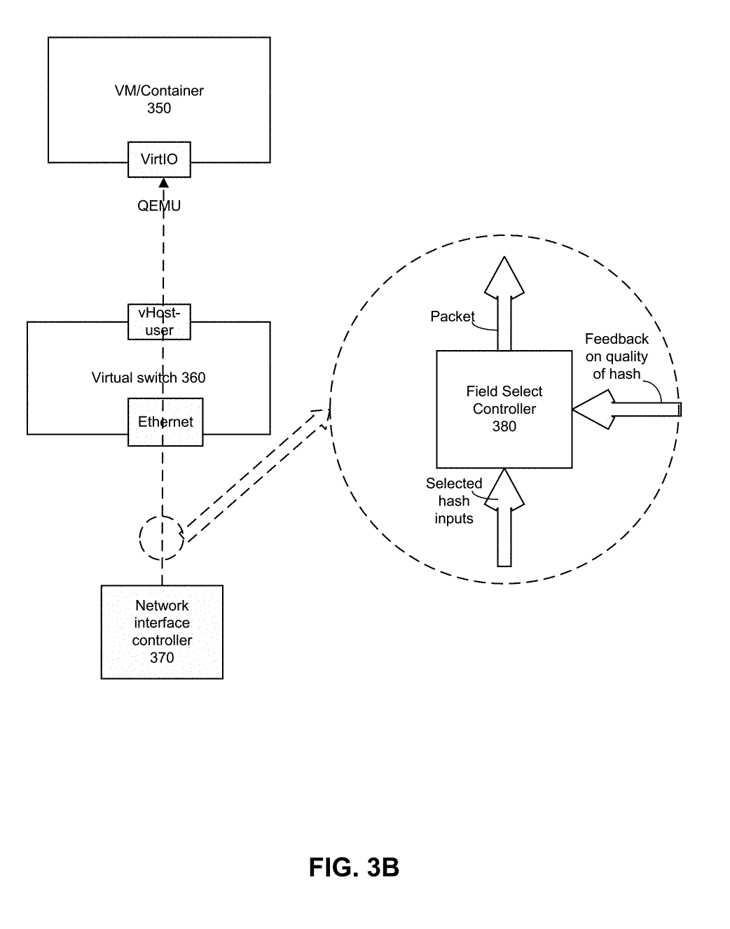

FIG. 3A depicts an example system that can be used. A host system or network interface can use the system of FIG. 3A in connection with processing a packet for transmission or re-transmission. The packet can be received from another device or a transmission initiated by a virtual machine, container, application, or other software. Various embodiments can be used in network interfaces, routers and switches, or where hash-based lookups are to be used. An example is provided next for processing a received packet. Transceiver 302 can receive a packet from a wired or wireless network medium and perform physical layer processing (PHY) and media access control (MAC) layer processing on the packet. Field select controller 304 can process the received packet by determining which field(s) or portion(s) of the received packet are to be used in a hash calculation by flow table lookup block 306. In some cases, a received packet specifies which field(s) or portion(s) of the received packet are to be used in a hash calculation by flow table lookup 306 for that received packet or packets received after specification of which field(s) or portion(s) to use in a hash calculation. Selected fields can be MAC address, 5tuple, virtual local area network (VLAN) tag, or higher layer protocol fields (or portions thereof) can be selected for use. In some cases, a received packet can specify a hashing algorithm to use for the received packet or other received packets. In some embodiments, hash inputs can be specified for use for particular flows or input ports. If a received packet does not specify which field(s) or portion(s) of the received packet are to be used in a hash calculation by flow table lookup 306 used by virtual switch 320, then field select controller 304 can apply configured settings and provide specified field(s) or portion(s) of the received packet to flow lookup table 306.

Flow table lookup block 306 can perform a hash calculation using the provided field(s) or portion(s) of the received packet. Examples of hash calculations include but are not limited to SHA-256 or MD-5, among others. Based on the calculated hash, flow table lookup block 306 can retrieve an entry associated with the calculated hash from tables 308. If there is a match, then an additional verification step can take place using the provided field(s) or portion(s) of the received packet as well as other information from the received packet to verify that the entry is to be retrieved and use for the received packet. The lookup can specify how a packet or packets are to be uniquely handled using a rule, next destination (e.g., queue, output port), and how they can be distinguished, among others. Other examples of rules are dropping packets, mirroring, modifying fields, receive side scaling, or adding or removing protocol headers. Note that field selection and next action lookup can occur after receive side scaling allocation of packets to a core and associated queue.

The following provides an example of a hash table lookup procedure. A provided key is hashed to retrieve an index of a corresponding bucket in the table. A primary bucket and secondary bucket can be used to avoid duplicated key use. For example, a key can be 3-way hashed to generate a signature, a primary bucket index (that can refer to multiple buckets 0 to n), and a secondary bucket index (that can refer to multiple buckets 0 to m). Hashed keys that match a signature in a bucket lead to retrieval of the associated key-data pointer pairs. The key portion of the key-data pointer pair is compared against the key from the query. If there is a match, the data pointer can be used to retrieve the data that is requested. For example, the data pointer can be used to retrieve data (e.g., flow classification) into a cache.

Performance information of the lookups can be captured using performance information capture 322. For example, performance information can include one or more of: collision rate over a period of time, a percentage or number of table lookup misses over a period of time, flow rule evictions from tables 308 over a period of time, installation rates of rules into table 308 over a period of time, and other information. Field select controller 304 can receive flow lookup performance information 307 from performance information capture 322 that indicates performance of lookup operations using the provided field(s) or portion(s) of the received packet. Field select controller 304 can provide performance information 305 that indicates flow lookup performance information 307 and/or indicate recommended input(s) to use to hash a received packet.

Based at least on flow lookup performance information 307, field select controller 304 can use input selection element 303 to can select fields to recommend or use for hashing a received packet. For example, if one or more of the flow lookup performance information 307 is above a threshold level, input selection element 303 can determine what fields to provide to flow table lookup block 306. For example, input selection element 303 can determine the fields that are changing and identify those fields as recommended inputs using performance information 305 provided in a transmitted packet or local communication (including a transmission over a bus or interconnect). For example, performance information 305 can be provided for transmission to one or more transmitters of packets that transmit packets to the device (e.g., switch, router, network interface) that includes field select controller 304. In other examples, performance information 305 can be provided through local communication using inter-processor communications (IPC), remote procedure call (RPC), a database, or other manners. Performance information 305 can be provided for transmission to an orchestrator (e.g., Kubernetes or OpenStack) that manages flow table lookup operations for one or more virtual switches.

A transmitter, orchestrator, or other element can decide to accept or reject those recommended fields for use provided via performance information 305 and instead select its own fields to use as hash calculation inputs using a feedback packet. A feedback packet sent to the system of FIG. 3A can be used to specify to field select controller 304 what portion of a received packet to use to perform a hash calculation. In some embodiments, field select controller 304 can accept and use the recommended input fields specified in a feedback packet. In some embodiments, field select controller 304 can make independent decisions on what fields to use based on recommendations from input selection element 303.

Note that in the event of lookup misses, old entries in table 308 can be evicted. Old entries would be replaced over time with the new entries which use the newer hash calculation. Table 308 replaces entries when they are full and a new value is inserted. Table 308 can be setup to evict entries which have not been accessed in a certain amount of time, which would be the case for the entries which used the old hash calculation as these entries would no longer be hit.

In the example of FIG. 3A, virtual switch 320 can use flow table lookup 306 to determine a next action for a packet, switching/routing 310 to provide traffic to another VM or container, or transmit (TX) element 312 to transmit packets through a network medium. Virtual switch 320 can be any software and/or hardware device that provides one or more of: visibility into inter-VM communication; support for Link Aggregation Control Protocol (LACP) to control the bundling of several physical ports together to form a single logical channel; support for standard 802.1Q VLAN model with trunking; multicast snooping; IETF Auto-Attach SPBM and rudimentary required LLDP support; BFD and 802.1ag link monitoring; STP (IEEE 802.1D-1998) and RSTP (IEEE 802.1D-2004); fine-grained QoS control; support for HFSC qdisc; per VM interface traffic policing; network interface bonding with source-MAC load balancing, active backup, and L4 hashing; OpenFlow protocol support (including many extensions for virtualization), IPv6 support; support for multiple tunneling protocols (GRE, VXLAN, STT, and Geneve, with IPsec support); support for remote configuration protocol with C and Python bindings; support for kernel and user-space forwarding engine options; multi-table forwarding pipeline with flow-caching engine; and forwarding layer abstraction to ease porting to new software and hardware platforms. Non-limiting example of virtual switch 104 include Open vSwitch (OVS), vector packet processing (VPP), and Tungsten Fabric vRouter.

FIG. 3B depicts an example operating environment. Network interface controller 370 provides received packets from a network for packet re-transmission or receipt from a wired or wireless medium. Field Select Controller 380 provides hash input(s) according to embodiments described herein. Field select controller 380 can select inputs used to perform a hash on a received packet or packet available for transmission. The inputs can be selected based on specification by a remote transmitter, orchestrator, or hypervisor. In some embodiments, field select controller 380 can use feedback on quality of hash inputs to determine which inputs to use in a hash calculation where the hash calculation is used to lookup entries that specify next processing or actions for a packet. Feedback on quality of hash inputs can include a collision rate of hashes over a period of time, a percentage or number of table lookup misses for a hash calculation input over a period of time, flow rule evictions from lookup tables over a period of time, installation rates of rules into a lookup table over a period of time, and other information. In various embodiments, field select controller 380 can be implemented using any part or a combination of virtual swtich 360 or network interface controller 370.

Packets then enter virtual switch 360 (e.g., vSwitch) for lookup of a next action. Non-limiting example of virtual switch 360 include Open vSwitch (OVS), vector packet processing (VPP), and Tungsten Fabric vRouter. Virtual switch 360 can provide performance information concerning hashing and lookup operations according to embodiments described herein. Virtual switch 360 sends packets to virtual machine (VM) or container 350. The VM or container 350 can invoke a packet for transmission using network interface controller 370 or process contents of packets received using network interface controller 370.

Any type of virtualization platform can be used including Xen, kernel-based virtual machine (KVM), VMware, QEMU, and so forth. When a Linux operating system is used, a VirtIO virtualization framework can be used in connection with a QEMU virtualization platform to provide for communication with a virtual switch 360. Virtual switch 360 can use a Data Plane Development Kit (DPDK) vHost user port for interaction and Ethernet as a standard for receiving and transmitting packets. In other environments, OpenDataPlane can be used.

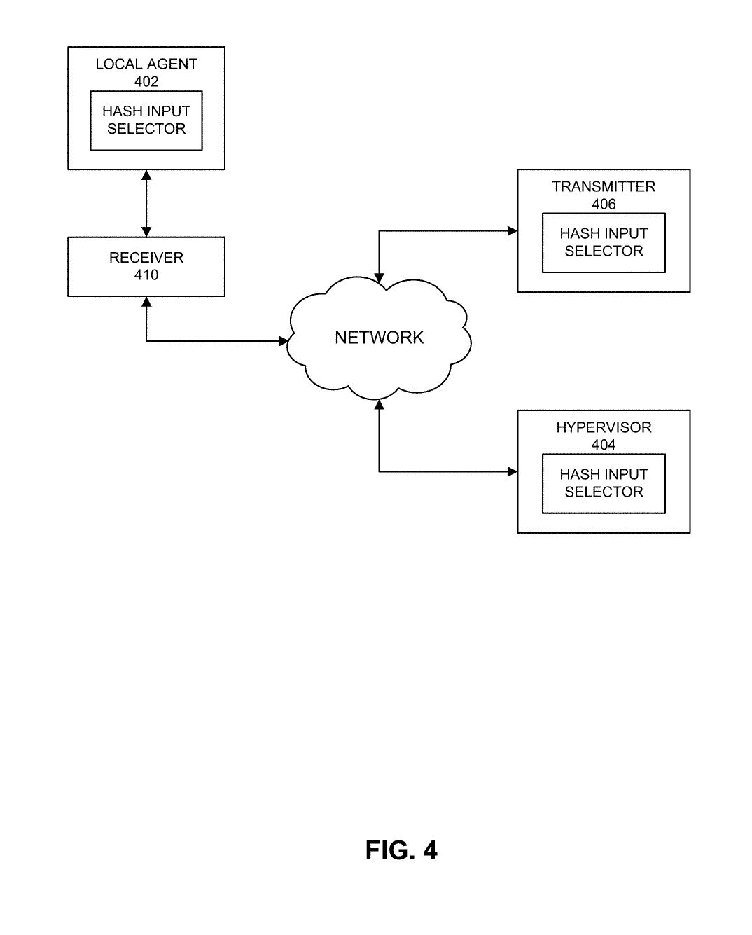

FIG. 4 depicts an example of a system where a receiver can transmit performance information related to lookups based on input fields. A local agent 402, hypervisor 404, transmitter 406 or other device or software can use the performance information provided or transmitted by a receiver 410 to select or specify one or more input fields to use to performance a lookup of flow related information. Local agent 402 can be connected to receiver using a local interface, interconnect, RPC, IPC, and so forth. Hypervisor 404 or transmitter 406 can receive performance information using a network such that a packet is formed to transmit the performance information. In some examples, multiple transmitters can receive the performance information.

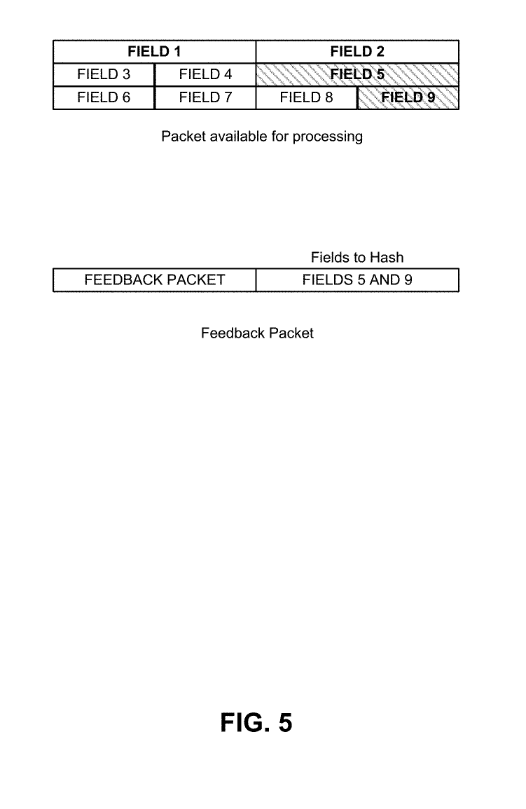

FIG. 5 depicts an examples of fields used to perform a lookup and fields suggested for use. The fields used for hash calculation are fields 1, 2, 5, and 9. Based on performance information, the fields suggested for use in the hash calculation are fields 5 and 9. For example, fields 5 and 9 can vary enough to reduce hash collisions. Fields 5 and 9 can be recommended as portions of a received packet to provide for hash-based lookups. A feedback packet transmitted to a receiver that uses a field selector identifies fields 5 and 9 to be used in hashes of received pacekts. Using this information, the field selector at a receiver selects fields 5 and 9 for hashes based off just these two fields for received packets.

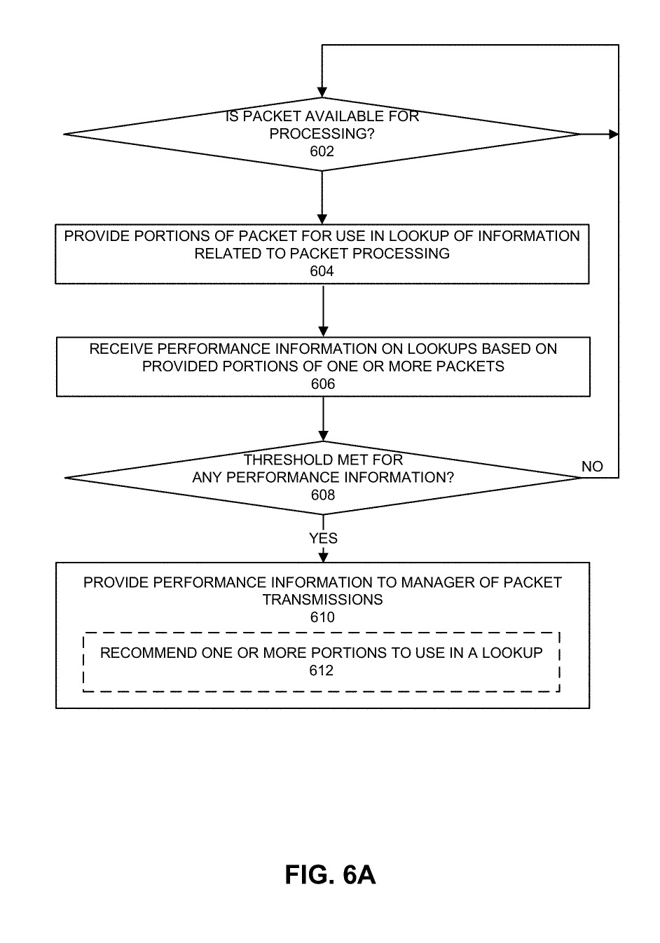

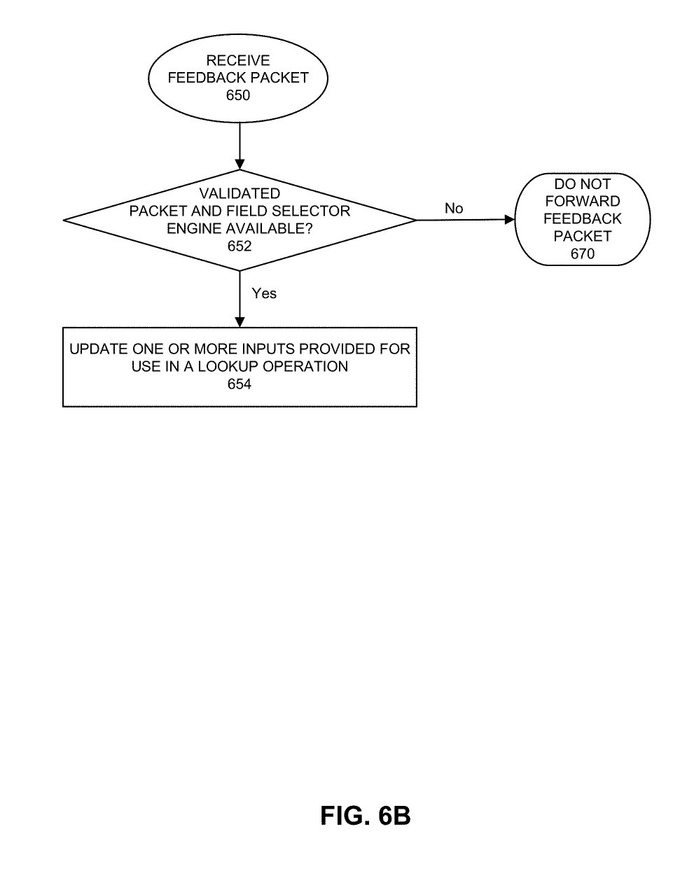

FIG. 6A depicts a process that can be used to manage portions of packets used to lookup packet processing actions. The process of FIG. 6A can be used by a field selector logic prior to hashing of a packet is performed to determine information (e.g., next action or flow information) for a packet. The process of FIG. 6A can be used by a network interface, virtual switch, host system, router, switch, or other system. At 602, a packet is available for processing. For example, a packet can be received from a network or available for transmission or re-transmission. At 604, portions of the packet can be provided for use to lookup information related to processing the pacekt packet. For example, one or more fields of the packet can be programmed to be provided for use in a hash calculation. The input fields can be programmed at compile time of a virtual switch. In some embodiments, the one or more fields can be modified during runtime of the virtual switch and a field selector logic (e.g., software and/or hardware) can select the input fields based on programming using a feedback packet received from a local or remote agent (e.g., software and/or hardware). For example, a process described with regard to FIG. 6B can be used to adjust one or more input fields used in a hash calculation. Thereafter, a lookup operation as described earlier can be used to determine information related to processing the packet. At 606, performance information on lookups based on provided portions of one or more packets can be received. For example, performance information can include collision rate over a period of time, a percentage or number of table lookup misses over a period of time, flow rule evictions from flow lookup tables over a period of time, installation rates of rules into flow lookup tables over a period of time, and other information. At 608, a determination can be made as to whether a threshold is met (or exceeded) for any of the performance information. For example, if a performance information can include collision rate over a period of time meets or exceeds a threshold, a percentage or number of table lookup misses over a period of time meets or exceeds a threshold, flow rule evictions from flow lookup tables over a period of time meets or exceeds a threshold, or installation rates of rules into flow lookup tables over a period of time meets or exceeds a threshold, then the provided portions can be considered to be related to causing excess hash collisions. If a threshold is met or exceeded for any of the performance information, then 610 can follow. If none of the thresholds is met and not exceeded for any of the performance information, then 602 can follow and the process can repeat. The threshold level for any of the performance information can be programmed by an orchestrator or administrator.

At 610, performance information can be provided to a manager of packet transmissions. The manager of packet transmissions can use the performance information to select one or more portions of received packets to use for a hash calculation related to looking up packet processing operations. The manager of packet transmissions can specify which one or more portions of received packets to use for a hash calculation using a feedback packet or feedback information provided to change configuration settings of a network interface, router, or switch. In some examples, a packet can include specification of which portion(s) to use to perform a hash calculation on that packet and a feedback packet is not separately transmitted. The manager of packet transmissions can be a transmitter of packets, orchestrator, hypervisor such as QEMU, XEN, Oracle VM VirtualBox, or local agent.

In some embodiments, 612 can be performed whereby a recommendation is made to use one or more portions in a lookup. For example, a field selector or virtual switch can provide a recommendation of input fields to select for a hash calculation. The recommendations can be accepted or rejected, in part or in whole, by a manager of packet transmissions that determines what input fields to use (e.g., MAC addresses, Ethernet type, VLAN tag, IP addresses, MPLS labels).

FIG. 6B depicts a process to selectively adjust a hashing calculation. The process can be used by a virtual switch, packet classifying application, network interface, router, switch, or host device, among others. At 650, a feedback packet is received. For example, a feedback packet can be identified based on a header setting, for example, the Ethernet type field, with a custom value not already used by a protocol can identify a feedback packet. A remote transmitter, orchestrator, hypervisor, local agent, or other device can transmit the feedback packet with specification of which portion of a received packet to use to perform a hash calculation. At 652, a determination is made as to whether a field selector element is available. A field selector element can be a hardware and/or software that can be programmed to select input fields to provide for a packet lookup operation. For example, one or more header fields (or portions thereof) in a received packet can be identified. For example, the header fields can include a VLAN ID, IP source and/or destination address, Ethernet type, MAC source and/or destination addresses, MPLS label, and so forth. In some embodiments, a validation can occur that the feedback packet can be used to adjust the one or more inputs for a lookup operation. A validation can include validating a source or destination IP addresses, source or destination MAC addresses, and/or packet header content. A field selector element can inspect packets to see if a feedback packet is validated. If a packet is validated and a field selector element is available for use, then 654 follows. If a field selector is not available for use or the packet is not validated, then 670 follows.

At 654, one or more inputs provided for use in a lookup operations are updated. For received packets processed after the feedback packet, one or more input fields selected by the feedback packet are used as a hash input to perform a lookup. In some examples, a feedback packet can specify which fields to use in a hash calculation and also a next action for the feedback packet can be performed using the specified fields. For example, a process such as that in FIG. 6A can be used to process packets using updated input fields.

At 670, the feedback packet can be discarded or not forwarded and made available for packet processing. If a feedback packet is not validated, it can be dropped or sent to a default queue for processing.

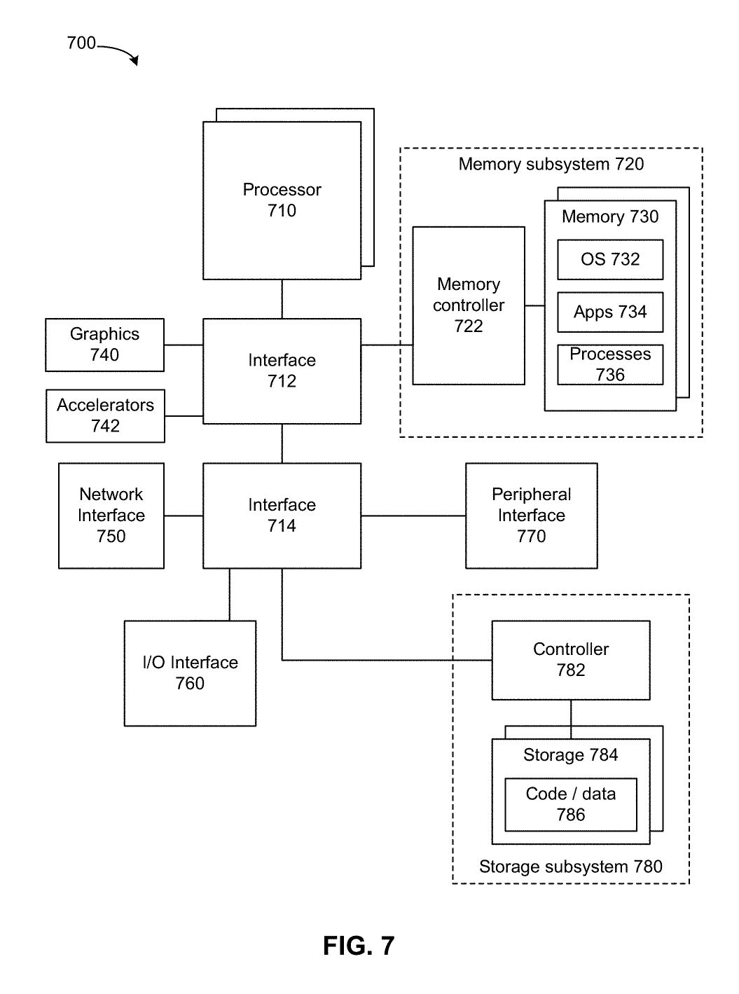

FIG. 7 depicts a system. The system can use embodiments described herein. System 700 includes processor 710, which provides processing, operation management, and execution of instructions for system 700. Processor 710 can include any type of microprocessor, central processing unit (CPU), graphics processing unit (GPU), processing core, or other processing hardware to provide processing for system 700, or a combination of processors. Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720, graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a fixed function offload engine that can be accessed or used by a processor 710. For example, an accelerator among accelerators 742 can provide compression (DC) capability, cryptography services such as public key encryption (PKE), cipher, hash/authentication capabilities, decryption, or other capabilities or services. In some embodiments, in addition or alternatively, an accelerator among accelerators 742 provides field select controller capabilities as described herein. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 742 can provide multiple neural networks, processor cores, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1374 bus.

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a remote device, which can include sending data stored in memory. Network interface 750 can receive data from a remote device, which can include storing received data into memory. Various embodiments can be used in connection with network interface 750, processor 710, and memory subsystem 720.

In one example, system 700 includes one or more input/output (I/O) interface(s) 760. I/O interface 760 can include one or more interface components through which a user interacts with system 700 (e.g., audio, alphanumeric, tactile/touch, or other interfacing). Peripheral interface 770 can include any hardware interface not specifically mentioned above. Peripherals refer generally to devices that connect dependently to system 700. A dependent connection is one where system 700 provides the software platform or hardware platform or both on which operation executes, and with which a user interacts.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (i.e., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (i.e., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A power source (not depicted) provides power to the components of system 700. More specifically, power source typically interfaces to one or multiple power supplies in system 700 to provide power to the components of system 700. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 700 can be implemented using interconnected compute sleds of processors, memories, storages, network interfaces, and other components. High speed interconnects can be used such as PCIe, Ethernet, or optical interconnects (or a combination thereof).

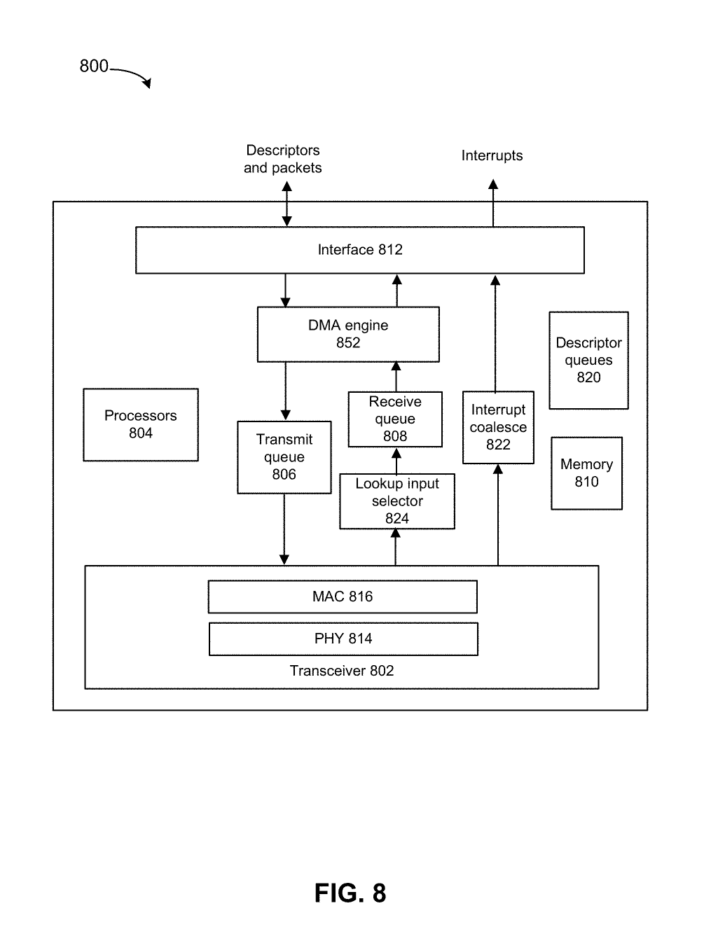

FIG. 8 depicts a network interface. Network interface 800 can use transceiver 802, processors 804, transmit queue 806, receive queue 808, memory 810, and bus interface 812, lookup input selector 824, and DMA engine 852. Transceiver 802 can be capable of receiving and transmitting packets in conformance with the applicable protocols such as Ethernet as described in IEEE 802.3, although other protocols may be used. Transceiver 802 can receive and transmit packets from and to a network via a network medium (not depicted). Transceiver 802 can include PHY circuitry 814 and media access control (MAC) circuitry 816. PHY circuitry 814 can include encoding and decoding circuitry (not shown) to encode and decode data packets according to applicable physical layer specifications or standards. MAC circuitry 816 can be configured to assemble data to be transmitted into packets, that include destination and source addresses along with network control information and error detection hash values. Processors 804 can be any a combination of a processor, core, graphics processing unit (GPU), field programmable gate array (FPGA), application specific integrated circuit (ASIC), or other programmable hardware device that allow programming of network interface 800. For example, a “smart network interface” can provide packet processing capabilities in the network interface using processors 804.

Lookup input selector 824 can provide selected portion(s) of a received packet to use in a hash calculation to use in a table lookup operation to determine how to process the received packet. For example, selected portion(s) of a packet can be specified in a packet or provided using another communication technique. The selected portion(s) can be based on hash performance based on prior selected portion(s) and can attempt to reduce hash collisions. The hash calculation can be used to access a lookup table that specifies a next processing step for a received packet. For example, receive side scaling (RSS) can be used to allocate the received packet for processing by a core or processor. In some cases, when RSS is used, the RSS-based core selection can be performed by lookup input selector 824 and the received packet provided to receive queue 808 with an indication of the core to process the received packet. Functionality of lookup input selector 824 can instead or in addition be provided for use before a virtual switch/packet processing application performs a lookup on a packet.

Interrupt coalesce 822 can perform interrupt moderation whereby network interface interrupt coalesce 822 waits for multiple packets to arrive, or for a time-out to expire, before generating an interrupt to host system to process received packet(s). Receive Segment Coalescing (RSC) can be performed by network interface 800 whereby portions of incoming packets are combined into segments of a packet. Network interface 800 provides this coalesced packet to an application.

Direct memory access (DMA) engine 852 can copy a packet header, packet payload, and/or descriptor directly from host memory to the network interface or vice versa, instead of copying the packet to an intermediate buffer at the host and then using another copy operation from the intermediate buffer to the destination buffer.

Memory 810 can be any type of volatile or non-volatile memory device and can store any queue or instructions used to program network interface 800. Transmit queue 806 can include data or references to data for transmission by network interface. Receive queue 808 can include data or references to data that was received by network interface from a network. Descriptor queues 820 can include descriptors that reference data or packets in transmit queue 806 or receive queue 808. Bus interface 812 can provide an interface with host device (not depicted). For example, bus interface 812 can be compatible with PCI, PCI Express, PCI-x, Serial ATA, and/or USB compatible interface (although other interconnection standards may be used).

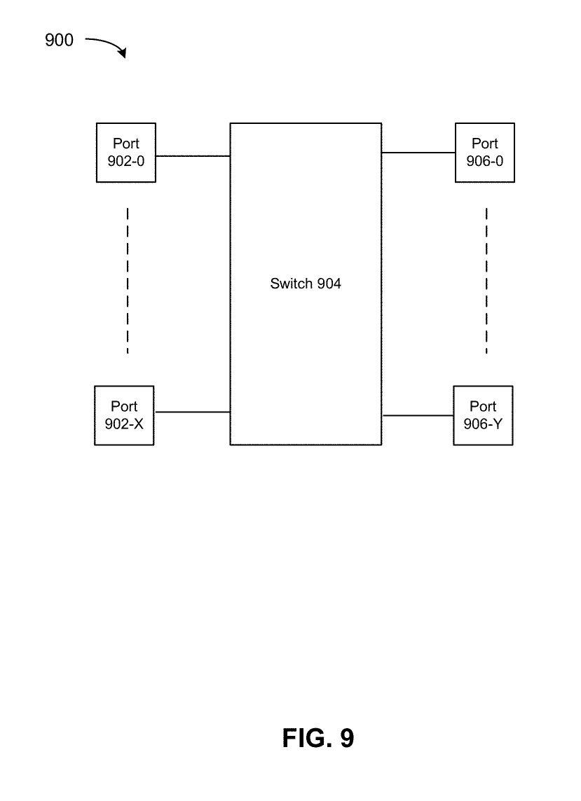

FIG. 9 depicts a switch. Various embodiments can be used in or with the switch of FIG. 9. Switch 904 can route packets or frames of any format or in accordance with any specification from any port 902-0 to 902-X to any of ports 906-0 to 906-Y (or vice versa). Any of ports 902-0 to 902-X can be connected to a network of one or more interconnected devices.

Similarly, any of ports 906-0 to 906-X can be connected to a network of one or more interconnected devices. Switch 904 can decide which port to transfer packets or frames to using a table that maps packet characteristics with an associated output port. In addition, switch 904 can perform packet replication for forwarding of a packet or frame to multiple ports and queuing of packets or frames prior to transfer to an output port.

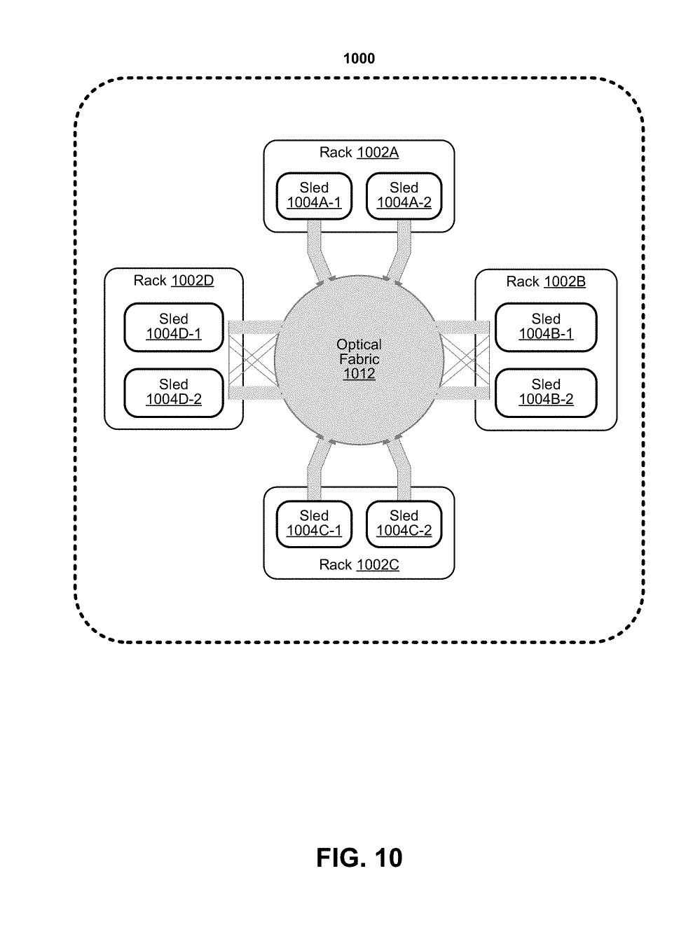

FIG. 10 depicts an example of a data center. Various embodiments can be used in or with the data center of FIG. 10. As shown in FIG. 100, data center 1000 may include an optical fabric 1012. Optical fabric 1012 may generally include a combination of optical signaling media (such as optical cabling) and optical switching infrastructure via which any particular sled in data center 1000 can send signals to (and receive signals from) the other sleds in data center 1000. The signaling connectivity that optical fabric 1012 provides to any given sled may include connectivity both to other sleds in a same rack and sleds in other racks. Data center 1000 includes four racks 1002A to 1002D and racks 1002A to 1002D house respective pairs of sleds 1004A-1 and 1004A-2, 1004B-1 and 1004B-2, 1004C-1 and 1004C-2, and 1004D-1 and 1004D-2. Thus, in this example, data center 1000 includes a total of eight sleds. Optical fabric 10012 can provide sled signaling connectivity with one or more of the seven other sleds. For example, via optical fabric 10012, sled 1004A-1 in rack 1002A may possess signaling connectivity with sled 1004A-2 in rack 1002A, as well as the six other sleds 1004B-1, 1004B-2, 1004C-1, 1004C-2, 1004D-1, and 1004D-2 that are distributed among the other racks 1002B, 1002C, and 1002D of data center 1000. The embodiments are not limited to this example. For example, fabric 1012 can provide optical and/or electrical signaling.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” “logic,” “circuit,” or “circuitry.”

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes an apparatus comprising: at least one memory and at least one processor communicatively coupled to the at least one memory, wherein the at least one processor is to: provide a first set of one or more portions of a packet for use in a lookup operation; receive feedback indicating lookup performance over a time period; and cause transmission of a performance indication based on the lookup performance meeting or exceeding a threshold level.

Example 2 includes the subject matter of Example 1, wherein the at least one processor is to: receive an indication to use a second set of one or more portions that are different at least in part from the one or more portions of the first set; access a second packet; and provide the second set of one or more portions of the second packet for use in a lookup operation.

Example 3 includes the subject matter of any of Examples 1-2, wherein the at least one processor is to: determine a second set of one or more portions that are different at least in part from the one or more portions of the first set based on the lookup performance meeting or exceeding a threshold level and cause transmission of the determined second set.

Example 4 includes the subject matter of any of Examples 1-3, wherein the at least one processor is to: receive an indication to use a third set of one or more portions that are different at least in part from the one or more portions of the second set; access a second packet; and provide the third set of one or more portions of the second packet for use in a lookup operation.

Example 5 includes the subject matter of any of Examples 1-4, wherein the performance indication includes one or more of: collision rate over a period of time, a percentage or number of table lookup misses over time, flow rule evictions from flow lookup tables over a period of time, or installation rates of rules into flow lookup tables over a period of time.

Example 6 includes the subject matter of any of Examples 1-5, wherein the one or more portions comprise one or more of: a header field, a portion of a header field, or a virtual local area network tag.

Example 7 includes the subject matter of any of Examples 1-6, wherein the at least one processor is to: access a received packet; perform a hash calculation using the first set of one or more portions of the received packet; and perform a lookup operation using the hash calculation, wherein the lookup operation is to indicate at least a next action to be performed based on the received packet.

Example 8 includes the subject matter of any of Examples 1-7, wherein the at least one processor is to: access a received packet; determine the received packet includes an indication of a second set of one or more portions of a packet to provide for a lookup operation; and discard the received packet based on inability to change one or more portions of a packet to provide for a lookup operation.

Example 9 includes the subject matter of any of Examples 1-8, wherein the apparatus comprises one or more of: a network interface, a host system, an offload engine, or a virtual switch.

Example 10 includes a method comprising: providing a first set including one or more portions of a first packet for a lookup operation; receiving a lookup performance indication from hash operations using the first set of one or more portions of multiple packets; in response to the lookup performance indication meeting or exceeding a threshold, causing transmission of the lookup performance indication; receiving an identification of a second set including one or more portions of a packet; receiving a second packet; and providing the second set of one or more portions of the second packet for a second lookup operation.

Example 11 includes the subject matter of Example 10, wherein the first set and the second set are different.

Example 12 includes the subject matter of any of Examples 10-11, wherein the lookup performance indication comprises one or more of: hash collision rate over a period of time, a percentage or number of table lookup misses over time, flow rule evictions from flow lookup tables over a period of time, or installation rates of rules into flow lookup tables over a period of time.

Example 13 includes the subject matter of any of Examples 10-12, wherein the one or more portions comprise one or more of: a header field, a portion of a header field, or a virtual local area network tag.

Example 14 includes the subject matter of any of Examples 10-13, wherein the receiving an identification of a second set including one or more portions of a packet comprises receiving a feedback packet including the second set.

Example 15 includes the subject matter of any of Examples 10-14, further comprising: performing a hash calculation using the first set including one or more portions of the first packet and performing a lookup operation using the hash calculation, wherein the lookup operation provides at least a next action for the first packet.

Example 16 includes the subject matter of any of Examples 10-15, wherein the lookup operation comprises receive side scaling (RSS) and the next action comprises storing the first packet into a queue associated with a core.

Example 17 includes a system comprising: a network interface; at least one processor communicatively coupled to the network interface, wherein the at least one processor to: access a first packet; provide a first set comprising one or more portions of the first packet for a lookup; receive an indication to use a second set comprising one or more portions of a packet for a lookup; access a second packet; and provide the second set comprising one or more portions of the second packet for a lookup.

Example 18 includes the subject matter of Example 17, wherein the at least one processor is to: provide lookup performance information based on use of the first set causing lookup performance to meet or exceed a threshold, wherein the lookup performance information comprises one or more of: hash collision rate over a period of time, a percentage or number of table lookup misses over time, flow rule evictions from flow lookup tables over a period of time, or installation rates of rules into flow lookup tables over a period of time.

Example 19 includes the subject matter of any of Examples 17-18, wherein the at least one processor is to: perform a hash calculation using the first set including one or more portions of the first packet and perform a lookup operation using the hash calculation, wherein the lookup operation is to indicate at least a next action for the first packet.

Example 20 includes the subject matter of any of Examples 17-19, comprising a compute sled, rack, or server computer.

What is claimed is:

1. An apparatus comprising:
at least one memory and
at least one processor communicatively coupled to the at least one memory, wherein the
at least one processor is to:
provide a first set of one or more portions of a packet for use in a lookup operation;
receive feedback indicating lookup performance over a time period; and
cause transmission of a performance indication based on the lookup performance meeting or exceeding a threshold level.

2. The apparatus of claim 1, wherein the at least one processor is to:
receive an indication to use a second set of one or more portions that are different at least in part from the one or more portions of the first set;
access a second packet; and
provide the second set of one or more portions of the second packet for use in a lookup operation.

3. The apparatus of claim 1, wherein the at least one processor is to:
determine a second set of one or more portions that are different at least in part from the one or more portions of the first set based on the lookup performance meeting or exceeding a threshold level and
cause transmission of the determined second set.

4. The apparatus of claim 3, wherein the at least one processor is to:
receive an indication to use a third set of one or more portions that are different at least in part from the one or more portions of the second set;
access a second packet; and
provide the third set of one or more portions of the second packet for use in a lookup operation.

5. The apparatus of claim 1, wherein the performance indication includes one or more of: collision rate over a period of time, a percentage or number of table lookup misses over time, flow rule evictions from flow lookup tables over a period of time, or installation rates of rules into flow lookup tables over a period of time.

6. The apparatus of claim 1, wherein the one or more portions comprise one or more of: a header field, a portion of a header field, or a virtual local area network tag.

7. The apparatus of claim 1, wherein the at least one processor is to:
access a received packet;
perform a hash calculation using the first set of one or more portions of the received packet; and
perform a lookup operation using the hash calculation, wherein the lookup operation is to indicate at least a next action to be performed based on the received packet.

8. The apparatus of claim 1, wherein the at least one processor is to:
access a received packet;
determine the received packet includes an indication of a second set of one or more portions of a packet to provide for a lookup operation; and
discard the received packet based on inability to change one or more portions of a packet to provide for a lookup operation.

9. The apparatus of claim 1, wherein the apparatus comprises one or more of: a network interface, a host system, an offload engine, or a virtual switch.

10. A method comprising:
providing a first set including one or more portions of a first packet for a lookup operation;
receiving a lookup performance indication from hash operations using the first set of one or more portions of multiple packets;
in response to the lookup performance indication meeting or exceeding a threshold, causing transmission of the lookup performance indication;
receiving an identification of a second set including one or more portions of a packet;
receiving a second packet; and
providing the second set of one or more portions of the second packet for a second lookup operation.

11. The method of claim 10, wherein the first set and the second set are different.

12. The method of claim 10, wherein the lookup performance indication comprises one or more of: hash collision rate over a period of time, a percentage or number of table lookup misses over time, flow rule evictions from flow lookup tables over a period of time, or installation rates of rules into flow lookup tables over a period of time.

13. The method of claim 10, wherein the one or more portions comprise one or more of: a header field, a portion of a header field, or a virtual local area network tag.

14. The method of claim 10, wherein the receiving an identification of a second set including one or more portions of a packet comprises receiving a feedback packet including the second set.

15. The method of claim 10, further comprising:
performing a hash calculation using the first set including one or more portions of the first packet and
performing a lookup operation using the hash calculation, wherein the lookup operation provides at least a next action for the first packet.

16. The method of claim 15, wherein the lookup operation comprises receive side scaling (RSS) and the next action comprises storing the first packet into a queue associated with a core.

17. A system comprising:
a network interface;
at least one processor communicatively coupled to the network interface, wherein the at least one processor to:
access a first packet;
provide a first set comprising one or more portions of the first packet for a lookup;
receive an indication to use a second set comprising one or more portions of a packet for a lookup;
access a second packet; and
provide the second set comprising one or more portions of the second packet for a lookup.

18. The system of claim 17, wherein the at least one processor is to:
provide lookup performance information based on use of the first set causing lookup performance to meet or exceed a threshold, wherein the lookup performance information comprises one or more of: hash collision rate over a period of time, a percentage or number of table lookup misses over time, flow rule evictions from flow lookup tables over a period of time, or installation rates of rules into flow lookup tables over a period of time.

19. The system of claim 18, wherein the at least one processor is to:
perform a hash calculation using the first set including one or more portions of the first packet and
perform a lookup operation using the hash calculation, wherein the lookup operation is to indicate at least a next action for the first packet.

20. The system of claim 17, comprising a compute sled, rack, or server computer.
